(19) United States
(12) Patent Application Publication
(10) Pub. No.: US 2004/0078250 A1
(43) Pub. Date: Apr. 22, 2004

(54) Dedicated risk management line of credit

(76) Inventor: Robert B. Schorb, Shawnee, KS (US)

Correspondence Address: STINSON MORRISON HECKER LLP, ATTN: PATENT GROUP, 1201 WALNUT STREET, SUITE 2800, KANSAS CITY, MO, 64106-2150, US

(21) Appl. No.: 10/606,077

(22) Filed: Jun. 25, 2003

Related U.S. Application Data
(60) Provisional application No. 60/391,481, filed on Jun. 25, 2002.

(51) Int. Cl. G06F 17/60

(52) U.S. Cl. 705/4

(57) ABSTRACT

A dedicated line of credit restricted to use for eligible demands from claimants, and a method for managing the retention of risk. The dedicated line of credit is available for an amount of time roughly equal to the term of coverage of a corresponding insurance policy. The method for managing the retention of risk comprises determining an estimate for the amount of future claims, calculating the cost of insurance, determining the entity's optimum amount of retained risk and providing a mechanism to pay the portion of claims for which the entity has retained responsibility.

### CROSS-REFERENCE TO RELATED APPLICATIONS

Provisional Application Serial No. 60/391,481, filed Jun. 25, 2002

### STATEMENT REGARDING FEDERALLY SPONSORED RESEARCH OR DEVELOPMENT

Not Applicable.

### BACKGROUND OF THE INVENTION

1. Field of the Invention

This present invention relates generally to a financial service product and system of risk management and, is more specifically directed to a dedicated line of credit and methodology for managing a person or entity's amount of retained exposure to future undetermined liabilities.

2. Description of Related Art

Traditionally, entities, whether individual or corporate which are not insurance or re-insurance companies, protect themselves against perceived risks by purchasing insurance. Risks may include damage to property, liabilities, medical costs, disability and loss of life and if the entity is an employer, these risks may also include employee benefit programs and other coverage necessary to maintain business relationships. However, due to economic pressures on insurance carriers, premiums paid by all entities have continually increased.

One way to lower the cost of obtaining insurance is for an entity to retain part of the risk before the insurance benefits would be payable. Deductibles and coinsurance are two common examples of how an entity retains risk. With a deductible, the insurance benefit is payable as demands from claimants occur, but the amount paid is only that part of the loss that exceeds the deductible amount. In coinsurance, there is no minimum amount that the entity must pay before insurance benefits are paid out, but the benefits only cover a specific percentage of the loss.

Economic pressures also have caused the insurance carriers to limit the number of plans they offer so that in many instances only higher deductible programs are available. The result, for some lines of coverage, is that premium increases have continued to escalate and that lower deductibles are no longer available, even if the premium was affordable. This has also put more pressure on entities to retain risk and left them with the consequences of an uncertain expense category, which is a risk to assets and financial stability.

As insurance costs continue to increase, some entities completely ignore the financial risk of retaining insurable risk merely to reduce the cost of buying insurance. In spite of the significant adverse financial and reporting consequences, an entity may retain the entire risk for some types of potential losses and buy insurance that protects them only in the event of a large catastrophic specific loss or the aggregation of several losses. On the other hand, due to a lack of certainty in loss projections and the potential risk to assets in order to satisfy the payment of claims, some entities are willing to retain only a minimal amount of risk.

Entities that want to reduce their insurance costs by retaining some of the risk must figure out how to pay future claims not covered by insurance. To financially plan for these future costs, entities typically estimate the number and severity of future claims and then put money aside to pay this expense. Usually this involves allocating funds on a monthly basis. However, claims are rarely incurred as an equal monthly cost throughout the year. While an entity's estimate of the total cost of the claims for the year might be correct, all of the claims might occur within the first month. Thus, in order to pay the claimants, liquidation of current assets may be required. Such asset liquidation may be adverse to growth and revenue stability.

In view of the foregoing, it is believed that there is a need for a method to determine the real cost of retaining risk and determine when it is advantageous to retain risk rather than buy traditional insurance. In addition, there is need for a product which will enable an entity to pay claims based on retained risk on a current year basis, without having to liquidate assets to meet this financial need in the current year.

### BRIEF SUMMARY OF THE INVENTION

The present invention is directed to a dedicated line of credit and to a method for risk management, wherein an entity can retain more risk and use the dedicated line of credit to pay claims made against the entity incurred within the risk retained.

In the preferred embodiment, the dedicated line of credit extends a specified amount of credit to a borrower for a specified time period to cover the demands of claimants from the risks retained by the entity. The credit available to the entity is restricted to use for eligible demands from claimants. Preferably, the dedicated line of credit is available for an amount of time roughly equal to the term in which claims could be made under a corresponding insurance policy.

In a preferred embodiment, the line of credit is managed by an administrator. The administrator would review the incoming claims and determine if they are eligible to be paid by the dedicated line of credit. Preferably, such restrictions are similar or identical to claims that would qualify for reimbursement under the terms of a corresponding insurance policy.

The dedicated line of credit is preferably either a separate and distinct restricted line of credit or a specific provision in a general purpose line of credit where the funds are distinguished from all other funds. The existence of the dedicated line of credit provides the insurance provider additional security that the funds are available for claims for which they are not providing coverage. In addition, the dedicated line of credit allows an entity to budget for claim fluctuations.

The present invention is also directed to a method for managing the retention of risk. This method of managing risk retention comprises the steps of (1) determining an estimate for the amount of future claims that could be brought against the entity; (2) calculating the cost of insurance the entity should obtain to alleviate the risk due to the potential future claims; (3) determining the entity's optimum amount of retained risk; and (4) providing a mechanism to pay the portion of claims for which the entity has retained responsibility. Preferably, the mechanism used to pay the claims is a dedicated line of credit.

For purposes of this description, it should be understood that the term ‘entity’ can reflect any person, individual, company or other legal entity that would have need of protecting themselves against perceived risks by purchasing insurance. It should also be understood that ‘entity’ does not include any company that is recognized by any insurance regulatory authority as an insurance or re-insurance company.

### BRIEF DESCRIPTION OF THE DRAWINGS

FIG. 1 is a is a flow chart of the steps performed to determine the cost of traditional insurance in accordance with the method of the present invention.

FIG. 2 is a is a flow chart of the steps performed to determine the cost of using a dedicated line of credit in accordance with the method of the present invention.

### DETAILED DESCRIPTION OF PREFERRED EMBODIMENT

The present invention is directed to a dedicated line of credit and a method for managing risk of retention that enables an entity to determine the optimal amount of risk retention for each type of risk and reduce overall costs for insurance against loss.

The dedicated line of credit is preferably an arrangement in which a bank, vendor or other entity extends a specified amount of credit to a borrower for a specified time period to cover the demands of claimants from the risks retained by the entity. In exchange for having ready access to the specified amount of money, the borrower typically pays the bank or vendor a fee. The fee may be broken down into two parts. The first part of the fee is the fixed costs associated with setting up the dedicated line of credit. The fixed costs include underwriting fees, commitment fees as well as administrative costs. The second part of the fee is the variable costs. The variable costs are the fees charged that vary depending on the size of the line of credit and the interest rate at which money borrowed is paid back to the bank or vendor. The borrower may be required to pay points to lower the resultant interest rate or to increase the amount available in the dedicated line of credit.

The dedicated line of credit is preferably available to the borrower for a specific amount of time. In the preferred embodiment, the dedicated line of credit is available for an amount of time roughly equal to the term in which claims could be made under a corresponding insurance policy. Preferably, the term of an insurance policy is one year with an additional amount of time in which to make claims. However, other periods of time could also be used in conjunction with the present invention. When the borrower utilizes the dedicated line of credit, it may be required to pay that amount back to the bank or vendor, plus interest, in a specific amount of time. A typical amount of time would be three years, but any amount of time or payback provision could be negotiated by the parties.

In the preferred embodiment of the present invention, the dedicated line of credit is preferably either a separate and distinct restricted line of credit or a specific provision in a general purpose line of credit where the funds are distinguished from all other funds. A key requirement is that the credit be dedicated to use for paying the demands of claimants. The dedicated line of credit can be used by either an individual or other entity such as a business. It is to be understood that the term ‘entity’ can reflect any person, individual, company or other legal entity that would have need of protecting themselves against perceived risks by purchasing insurance. It should also be understood that ‘entity’ does not include any company that is recognized by any insurance regulatory authority as an insurance or re-insurance company

As previously noted, the dedicated line of credit is preferably used in connection with a specific insurance policy. Although the type of insurance policy does not matter, the dedicated line of credit is designed to pay the portion of claims that is not paid by the insurance policy up to the limits of the dedicated line of credit. In addition, the term of the dedicated line of credit could correspond with the term in which claims could be made under the insurance policy so that it will be available to pay the portion of claims for which coverage is not provided. The existence of the dedicated line of credit provides the insurance provider additional security that the claims against retained risk, i.e. deductibles, will be paid. In addition, the dedicated line of credit allows an entity to budget for claim fluctuations. For example, if an entity should happen to incur all of its projected insurance claims in the first month of its fiscal year, it may not have sufficient cash flow to cover a large deductible on its insurance policy. With a dedicated line of credit in place, a much larger deductible could be paid. The entity can then make payments over a period of time and thereby, reduce the immediate burden on its cash flow. This tool allows the entity to retain a larger portion of its risk, often in the form of a larger deductible. An entity that is willing to retain a larger amount of risk, decreases the risk associated with providing insurance, which will allow the insurance provider to offer lower premiums.

The dedicated line of credit is also established to provide the cash flow needed to pay claims against the entity and avoid the premature liquidation of assets. The dedicated line of credit is unique in that its funds are restricted and can only be utilized to meet the prospective demands of future claimants. In a preferred embodiment, the line of credit is managed by an administrator. The administrator could be the issuing bank, vendor or other entity, insurance company, re-insurer, a third party, or even someone within the borrowing entity. The administrator would review the incoming claims and determine if they are eligible to be paid by the dedicated line of credit. To be eligible, a claim must meet the specific requirements placed on the line of credit. Preferably, such restrictions are similar or identical to claims that would qualify for reimbursement under the terms of corresponding insurance. Alternatively, the restrictions could be coordinated with claims covered by corresponding insurance. Most preferably, to be eligible, a claim would be paid by the corresponding insurance, except for the fact that at least a portion of it falls within the deductible or other similar limitation on the requirement to pay the entire claim or because the entity has chosen retain the risk.

If a dedicated line of credit is associated with two or more insurance policies, the line of credit is typically segregated in such a manner as to distinguish the funds that are available to be used to cover claims against each separate insurance policy. However, the dedicated line of credit could also be a single line of credit in which the associated funds are available for payment of claims associated with more than one insurance policy. Different set ups of the dedicated line of credit are acceptable as long as the funds are only used to pay restricted claim expenditures. In a similar manner, if a specific provision in a general purpose line of credit is used, the line of credit could be segregated to create a dedicated line of credit to prevent any commingling of funds utilized on general purpose expenditures with those funds available to pay restricted claim expenditures. Preferably, before the funds of the dedicated line of credit could be used, the administrator would be required to determine that a claim was indeed deemed eligible under the guidelines set forth in the specific provision. The guidelines of the specific provision typically correspond with coverage provided in insurance policies or to meet regulatory requirements.

A second embodiment of the invention is directed to a method for managing the retention of risk. This method provides an evaluation and projection of the financial impact associated with risk retention and enables calculation of the real cost to the entity of various risk retention amounts. The end results of the calculations, based on various risk retention amounts, can be compared with one another so that the entity can select the optimal (i.e. lowest annual cost) combinations of insurance premiums and retained risk. This embodiment also provides a method and apparatus for determining when a dedicated line of credit is an advantageous supplement or alternative to insurance for the entity. To that extent, the higher degree of probability associated with the claim data, the greater chance the use of this method of managing the retention of risk will reduce cost to the entity. This embodiment does not provide certainty of the amounts of claims, it merely quantifies the cost of the claims projected and variations (higher or lower) from that projection by calculating the total adjusted cost at various levels. It then demonstrates this cost over the years allowed for repayment of the dedicated line of credit so that the optimal level of retained risk can be selected.

The need for a dedicated line of credit and, if needed, the size of the dedicated line of credit can be determined in several different ways. The first step is to determine an estimate for the amount of future claims that could be brought against the entity. One method of estimating the amount of future claims uses the estimated future claims against an entity as provided by the entity's actuary or other insurance professional. The actuary or insurance professional could also provide factors from which future claim projections can be calculated. A second method of estimating future claim amounts involves reviewing the claim history of previous years to provide a basis of comparison to determine a reasonable estimate of future claims. Any other method can be used to estimate the amount of future claims as long as the entity is comfortable that the figures are reasonably reliable.

Once the amount of future claims is estimated, the next step is to determine the amount of insurance the entity should obtain to alleviate the risk due to the potential future claims and how much exposure to liability the entity should keep. This can be done in several different ways. Traditionally, an entity will obtain estimates of costs associated with varying combinations of insurance coverage amounts and claim amounts for which coverage is not provided, i.e. deductibles. The entity will then evaluate this information and make a decision based upon its cash flow and how risk averse it desires/can afford to be. If an entity retains too much risk, payments to satisfy claims may require the liquidation of current assets, which in turn could disrupt growth and revenue stability. As such, retention of risk is a major consideration in financial planning.

In a most preferred embodiment, a series of calculations and steps are taken in order to determine whether the entity would benefit from the use of a dedicated line of credit in addition to or in place of its traditional insurance coverage. An example of a preferred method is described below.

### EXAMPLE

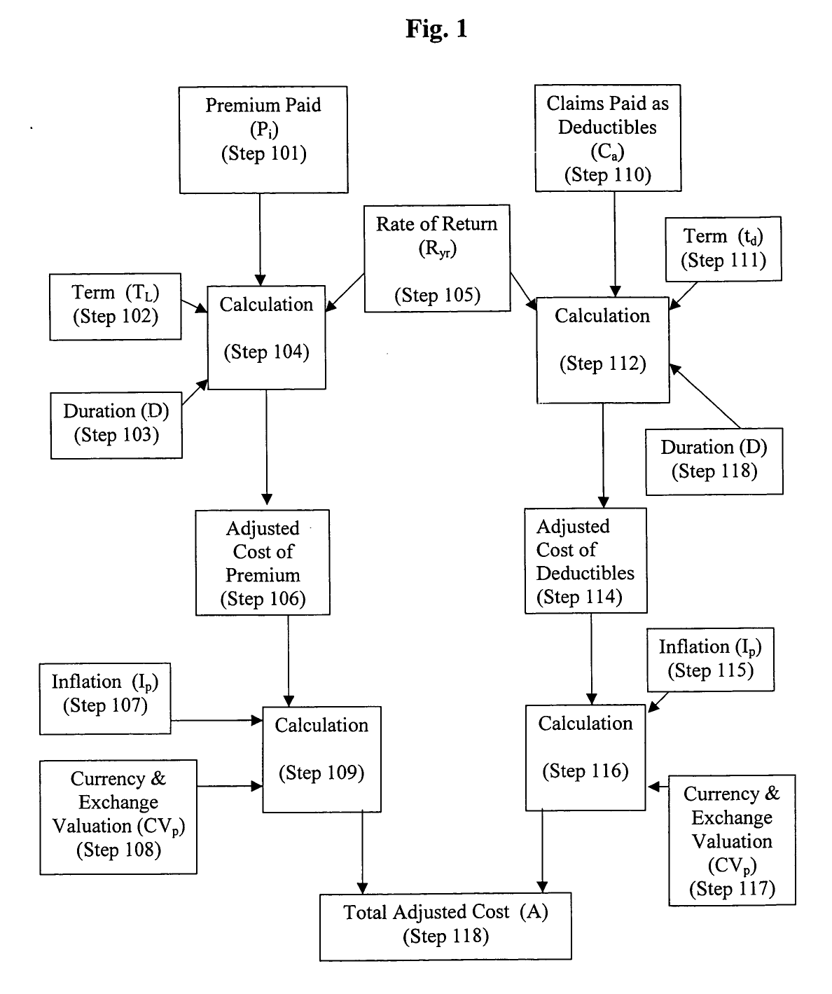

In order to provide an accurate comparison of the cost of insurance to the entity, the true cost needs to be determined over the same length of time the entity has to pay back any amounts used from the dedicated line of credit. As shown in FIG. 1, the actual cost to an entity of obtaining insurance is calculated through a number of steps. First, the entity determines the insurance premium (Pᵢ) 101 for a desired term of insurance coverage. Typically, the term of the insurance coverage is one year. However, any period of coverage could be used. As mentioned above, the entity must also determine the term of the dedicated line of credit (T_{L}) 102 and the additional duration (D) 103 for paying back the amount used from the dedicated line of credit so that cost comparisons for use of the dedicated line of credit are equivalent.

Next, the entity estimates its rate of return (R_{yr}) 105 from operations over the same length of time D and T_{L}. R_{yr} is the measure of what would have been gained during a specific period of time if funds were to be retained to support the activities of the entity. Because it is entered for each time period, it allows for variations in revenue and expenses. It can be entered in months, quarters or years and is a measure of the operating results for each period. The adjusted cost of the insurance premium 106 is calculated by multiplying the premium Pᵢ by the rate of return R_{yr}. If TL is one year and D is two years, then the calculation would be (Pᵢ)*[R_{yr1}+R_{yr2}*(1+R_{yr1})+R_{yr3} (1+R_{yr1}+R_{yr2}+R_{yr1}·R_{yr2})]. The adjusted cost of the premium 106 can also be modified by taking into account inflation (Iₚ) 107 and any currency and exchange valuations (CVₚ) to calculate an adjusted cost of premium 109 that provides more accurate values for comparison.

In addition to the cost of the insurance premium, the entity should determine the cost of claims paid as deductibles (Cₐ) 110. To calculate step 112 the adjusted cost of deductibles, the entity should multiply the deductible cost Cₐ by the rate of return R_{yr}. Using a three year duration D 118 to calculate the adjusted cost of deductibles 114, the equations would be (Cₐ)*[R_{yr1}+R_{yr2}*(1+R_{yr1})+R_{yr3} (1+R_{yr1}+R_{yr2}+R_{yr1}·R_{yr2})]. As with the adjusted costs of the premium 106, the adjusted cost of deductibles 114 can be modified to take into account inflation (Iₚ) 115 and currency and exchange valuations (CVₚ) 117 to calculate the true adjusted cost of deductibles 116.

The true adjusted cost of deductibles 116 is added to the true adjusted cost of the premium 109 to determine the total adjusted cost (A) 118 of insurance to the entity.

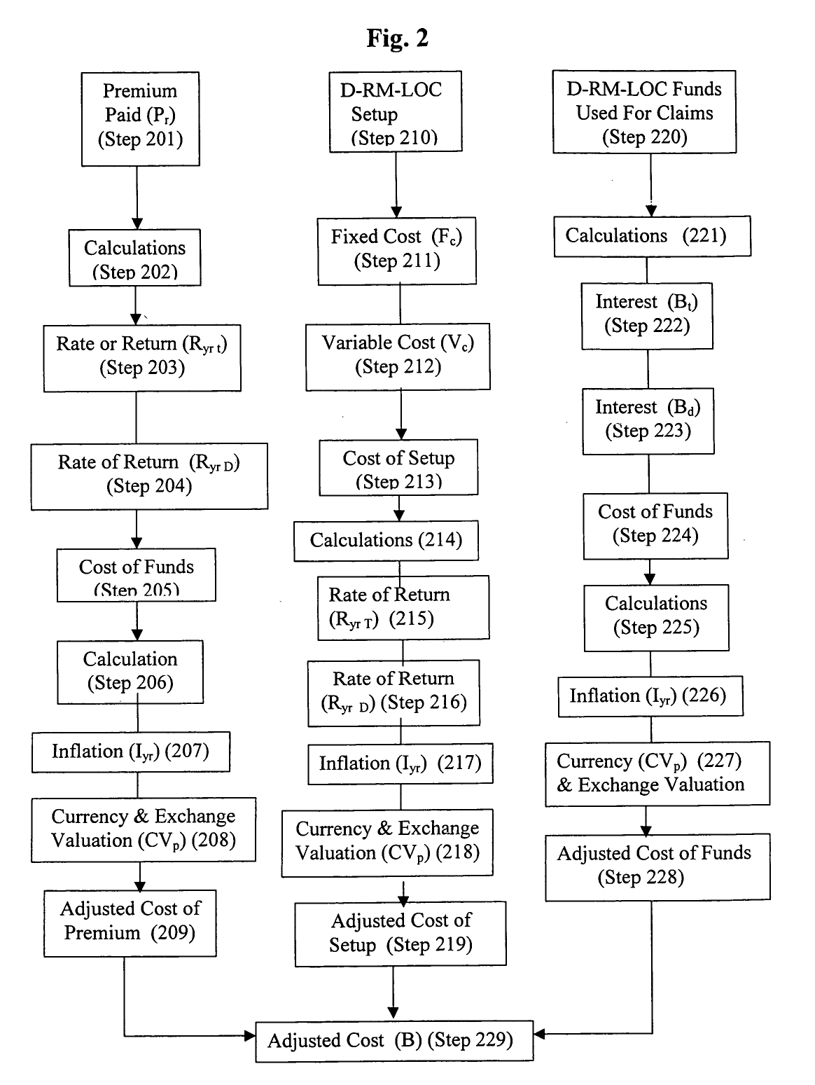

Turning to FIG. 2, the adjusted cost to an entity using the dedicated line of credit in addition to insurance is calculated through a number of steps. First, the entity determines the premium paid (Pᵣ) 201 and performs the calculations of step 202 to determine the adjusted cost of the premium paid as shown in step 205. The adjusted cost is determined by multiplying Pᵣ by the rate of return for the term of insurance coverage (R_{yr t}) and by the rate of return for the duration for which the line of credit will be paid back (R_{yr D}) 204. Thus, the adjusted cost equation for a insurance policy with a term of one year and a dedicated line of credit with a provision for a payback term of two years would be (Pᵣ*[R_{yr1}+R_{yr2}*(1+R_{yr1})+R_{yr3} (1+R_{yr1}+R_{yr2}+R_{yr1}·R_{yr2})]. The adjusted costs of the premium paid 209 can be adjusted for inflation step 207 and currency and exchange valuation step 208.

Next, the entity determines the cost for setting up the dedicated line of credit, step 201. The set-up fees are typically broken down by fixed costs (F_{c}) 211 and variable costs (V_{c}) 212. The fixed costs include underwriting fees, commitment fees as well as administrative costs. The variable costs are the fees charged that vary depending on the size of the line of credit and the interest rate at which money borrowed is paid back to the bank or vendor. The fixed cost and variable costs are added to determine the cost of the set-up as shown in step 213. The adjusted cost of set-up 219 is determined by performing the calculations in step 214 which involve multiplying the rate of return (R_{yr t}) 215 for the term for which the insurance premium covers, next multiply the cost of set-up by the rate of return (R_{yr D}) of step 216 for the remaining duration of time allowed for paying back the dedicated line of credit as well as taking into account inflation and any currency and exchange valuations.

The cost of setup 213 is determined by multiplying (F_{c}+V_{c}) by the rate of return for the term of insurance coverage (R_{yr t}) 215 and by the rate of return for the duration for which the line of credit will be paid back (R_{yr D}) 216. Thus, the cost of setup equation 214 for a insurance policy with a term of one year and a dedicated line of credit with a provision for a payback term of two years would be ((F_{c}+V_{c})*[R_{y1}+R_{yr2}*(1+R_{y1})+R_{yr3} (1+R_{yr1}+R_{yr2}+R_{yr1}·R_{yr2})]. The adjusted costs of the setup 219 can be adjusted for inflation step 217 and currency and exchange valuation step 218.

Finally, the entity determines the cost for using funds of the dedicated line of credit for claims, step 220. Although a single or variable interest rate could be charged on any amount used from the time it is borrowed, until the time it is paid back, interest fees may be broken down into two rates. The first interest rate (Bₜ) 222 applies to funds used during the term of the dedicated line of credit. The interest rate will be calculated based upon the days remaining in the term. The second interest rate (B_{d}) 223 applies to all funds once the term of the dedicated line of credit expires. B_{d} applies to the funds for the remaining term in which the entity has agreed to payback the loan.

To calculate the cost of funds 224, Bₜ is multiplied by each and every claim made on the dedicate line of credit for the period remaining for the dedicated line of credit. As a very simple example, if Bₜ is 12 percent and a claim is made on March 1^{st} of a year, the interest due on the claim would be 10 percent of the claim amount. It is to be understood that the interest rate could be compounded on a more frequent basis. Once the dedicated line of credit expires, B_{d} is then calculated on the entire amount of funds remaining for the duration of the payback period. The issuer of the dedicated line of credit may calculate an amortization of the loan based upon the term of the loan and Bₜ. However, any method of payment of the remaining amount could be used. The adjusted cost of funds 228 is determined by performing the calculations in step 225 which involve multiplying cost of funds 224 by the rate of return (R_{yr D}) for the remaining duration of time allowed for paying back the dedicated line of credit. The adjusted costs of funds 228 can be adjusted for inflation step 226 and currency and exchange valuation step 227.

The adjusted cost of premium 209 is added with the adjusted cost of setup 219 and adjust cost of funds to determine an entity's the total adjusted cost (B) 229 of the use of the dedicated line of credit.

The next step in the method of managing risk retention is to determine the optimum amount of retained risk. Using the calculations of the previous steps, a series of comparisons can be produced for the entity. The object of the previous calculations is to bring the two adjusted costs 118 and 229 into an equivalent format so that comparisons are valid on a current basis. To determine the optimum amount of retained risk, the two adjusted costs 118 and 229 are calculated for variations on the amount of retained risk as well as variations on the projected claim amounts. Future payment and liabilities are provided in output sheets so that accounting and fiscal planning processes can take these costs into consideration. The different variations in retained risk and projected claim amounts allows the entity to make fiscal determinations of the optimum amount of risk to retain. In addition to the internal financial planning benefit, this data may also be made available to those who have a financial interest in the entity as well as those considering a relationship where financial stability is an issue or regulatory reporting.

The next step in this method is to provide a mechanism to pay the portion of claims for which the entity has retained responsibility. In a most preferred embodiment, the mechanism used to pay the claims is the above described dedicated line of credit.

While it is contemplated that several types of insurance may be required to cover various types of potential liability, a single hypothetical insurance policy was described in this example for purposes of illustration. In a most preferred embodiment, an entity would use the following series of calculations and steps in the example for each type of insurance policy that is deemed necessary. In addition, the calculations would also be done for several different levels of retained risk and levels of insurance coverage.

In the example, the entity determines that it has potential claims of $1,000,000 that may be brought in the upcoming year. The entity decides that it will need to obtain coverage on any claims in excess of 120% of projected claims. To determine the cost of insuring this risk, the entity uses the steps of FIG. 1 for potential claims amounts of 100%, 120% and 140% of the projected claims. The insurance premium for coverage of claims in excess of 120% is $40,000. For simplicity's sake, the rate of return for the entity is a constant 15% and there is no inflation or currency and exchange valuations. In addition, the comparison will be based upon a three year term to pay back any funds used from the dedicated line of credit.

Using the formula of step 104, the opportunity cost of the insurance premium is approximately $21,000 for each level of potential claim amounts [40,000* [0.15+0.15*(1+0.15)+0.15*(1+0.15+0.15+0.15*0.15)]. For 100% of the projected claims, there is no opportunity lost for payment of excess claims. Since the entity is retaining responsibility for all claims up to $1,200,000, the insurance coverage would not kick in until claims exceed 120%. Thus, for 120% of the projected claims, the opportunity lost on the payment of $200,000 in excess claims over the projected amount is approximately $104,000 (using a similar calculation as that shown above). For claims totaling 140% of the projected amount, insurance will allow the entity to recover $200,000, but the entity will still have approximately $104,000 in lost opportunity costs on the first $200,000 paid in excess claims. Therefore, for claim demands totaling 100% of the projected claim amounts, the total cost to an entity retaining traditional insurance would be approximately $1,061,000 for payment of projected claims, excess claims, insurance premium and lost opportunity costs for money paid for premiums and excess claims. For claim demands totaling 120% of the projected claim amounts, the total cost to an entity retaining traditional insurance would be approximately $1,365,000 for payment of projected claims, excess claims, insurance premium and lost opportunity costs for money paid on premiums and excess claims minus any gains received from insurance recovery. For claim demands totaling 140% of the projected claim amounts, the total cost to an entity retaining traditional insurance would also be approximately $1,365,000 for payment of projected claims, excess claims, insurance premium and lost opportunity costs for money paid on premiums and excess claims minus any gains received from insurance recovery.

Next, the entity determines the adjusted cost if the entity were to retain 140% of the projected costs and employ a dedicated line of credit to assist with payment of any excess claims. The entity will still have a rate of return of 15% and will not be influenced by inflation or currency and exchange valuations. The new insurance premium for claims in excess of 140% of projections is $20,000. The term in which to pay back funds from the dedicated line of credit is 3 years at an interest rate of 11.5%.

Using the calculations of step 202, the opportunity cost of the insurance premium over the three year period is approximately $10,500 for each level of potential claim amounts [20,000*[0.15+0.15*(1+0.15)+0.15*(1+0.15+0.15+0.15*0.15)].] In addition, the opportunity gained on the money saved ($20,000) from the reduced premium would also be approximately $10,500. For 100% of the projected claims, there is no opportunity lost for payment of excess claims.

At 120% of the projected claims, the excess claims of $200,000 would be paid through the dedicated line of credit. Repayment of the $200,000 would take place over three years. The interest on the money borrowed would be $46,000. However, the opportunity gained from having access to $200,000 instead of having to pay the excess claims from cash flow or through asset liquidation is approximately $104,000. [200,000*[0.15+0.15*(1+0.15)+0.15*(1+0.15+0.15+0.15*0.1 5)]. Thus, the total cost to the entity would be 1,000,000 in projected claims, $200,000 in repayment of the line of credit and $46,000 in interest payments. These costs are offset by approximately $104,000 in opportunity gained for sum total of approximately $1,142,000.

At 140% of the projected claims the excess claims of $400,000 would be paid through the dedicated line of credit. Repayment of the $400,000 would take place over three years. The interest on the money borrowed would be $92,000. However, the opportunity gained from having access to $400,000 instead of having to pay the excess claims from cash flow or through asset liquidation is approximately $208,000. Thus, the total cost to the entity would be 1,000,000 in projected claims, $400,000 in repayment of the line of credit and $92,000 in interest payments. These costs are offset by approximately $208,000 in opportunity gained for sum total of approximately $1,284,000.

Analyzing the results from using traditional insurance and the use of the dedicated line of credit, the entity will determine that it will reap substantial saving through use of the dedicated line of credit. If the claim projections are correct, the entity will save approximately $61,000; if the claims exceed the projections by 20% the savings will be approximately $223,000; and if the claims exceed the projections by 40%, the savings will be approximately $81,000.

It is to be understood that the above example is a rough estimate of the costs and savings for each of the projected amounts of claims. In addition, it is noted that the numbers used in the calculations are not typically constants.

From the foregoing it will be seen that this invention is one well adapted to attain all ends and objectives herein-above set forth, together with the other advantages which are obvious and which are inherent to the invention.

Since many possible embodiments may be made of the invention without departing from the scope thereof, is to be understood that all matters herein set forth or shown in the accompanying drawings are to be interpreted as illustrative, and not in a limiting sense.

While specific embodiments have been shown and discussed, various modifications may of course be made, and the invention is not limited to the specific forms or arrangement of parts and steps described herein, except insofar as such limitations are included in the following claims. Further, it will be understood that certain features and sub-combinations are of utility and may be employed without reference to other features and sub-combinations. This is contemplated by and is within the scope of the claims.

What is claimed and desired to be secured by Letters Patent is as follows:

1. A method for managing a retention of risk by an entity comprising the steps of:
determining an estimate for an amount of future claims that could be brought against the entity;
calculating a cost of insurance the entity should obtain to alleviate the risk due to the potential future claims;
determining the entity's optimum amount of retained risk; and
providing a funding mechanism to pay a portion of claims for which the entity has retained responsibility.

2. The method for managing the retention of risk according to claim 1, wherein the funding mechanism used to pay the claims is a dedicated line of credit.
